(19) United States
(12) Patent Application Publication
(10) Pub. No.: US 2012/0096345 A1
(43) Pub. Date: Apr. 19, 2012

(54) RESIZING OF GESTURE-CREATED MARKINGS FOR DIFFERENT DISPLAY SIZES

(75) Inventors: Ronald Ho, Fremont, CA (US); Andrew A. Grieve, Waterloo (CA)

(73) Assignee: GOOGLE INC., Mountain View, CA (US)

(21) Appl. No.: 12/907,473

(22) Filed: Oct. 19, 2010

(51) Int. Cl. G06F 17/00

(52) U.S. Cl. 715/252

(57) ABSTRACT

Various embodiments are disclosed. According to one example embodiment, a method may include receiving a document at a first computing device having a display size that is different than a display size of a second computing device where a gesture-created marking was added to the document. The document may include the gesture-created image and a group of tagged characters. The method may further include adjusting a size or shape of the gesture-created marking in the document so that the gesture-created marking encompasses all tagged characters on the display of the first computing device. The adjusting may be performed based on the display size of the first computing device being different than display size of the second computing device.

### TECHNICAL FIELD

This description relates to the resizing of gesture-created markings for different display sizes.

### BACKGROUND

There are a wide variety of electronic or computing devices that may communicate electronically, such as through a network, e.g., wireless network, Internet or other network. These computing devices may come in a variety of sizes. Some of these devices may have a full-size screen, such as a desktop computer or a laptop. Mobile computing devices (or simply mobile devices), such as cell phones, PDAs (personal digital assistants), and other handheld or highly portable computing devices may typically have a screen size that is smaller than a full-size screen offered by most desktop and laptop computers. Problems may arise when displaying the same text, images and other information on both a full-size screen device and a mobile device having a smaller screen size, as some types of information may not be displayed in an accurate or consistent manner on both devices due to the differences in screen size.

### SUMMARY

According to one general aspect, an apparatus may include at least one processor, and at least one memory including computer program code, the at least one memory and the computer program code configured to, with the at least one processor cause the apparatus to at least receive, by a first computing device having a first display with a first display size, a document that was edited or created on a second computing device having a second display with a second display size that is different from the first display size. The document includes a gesture-created marking that encompassed a group of characters in the document when displayed on the second display. Each of the characters encompassed by the gesture-created marking were previously tagged by the second computing device as being encompassed by the marking The apparatus is further caused to reflow, by the first computing device, at least characters of the document to accommodate the first display size; and adjust, by the first computing device, based on the reflowing of the characters, a size or shape of the gesture-created marking in the document so that the gesture-created marking continues to encompass all tagged characters when displayed by the first computing device on the first display.

According to another general aspect, a method may include receiving, by a first computing device having a first display with a first display size, a document that was edited or created on a second computing device having a second display with a second display size that is different from the first display size. The document includes a gesture-created marking that encompassed a group of characters in the document when displayed on the second display. Each of the characters encompassed by the gesture-created marking were previously tagged by the second computing device as being encompassed by the marking The method further includes reflowing, by the first computing device, at least characters of the document to accommodate the first display size, and adjusting, by the first computing device, based on the reflowing of the characters, a size or shape of the gesture-created marking in the document so that the gesture-created marking continues to encompass all tagged characters when displayed by the first computing device on the first display.

According to another general aspect, a computer program product may be provided that is tangibly embodied on a computer-readable storage medium having executable-instructions stored thereon. The instructions are executable to cause a processor to receive, by a first computing device having a first display with a first display size, a document that was edited or created on a second computing device having a second display with a second display size that is different from the first display size. The document includes a gesture-created marking that encompassed a group of characters in the document when displayed on the second display. Each of the characters encompassed by the gesture-created marking were previously tagged by the second computing device as being encompassed by the marking The instructions further cause a processor to reflow, by the first computing device, at least characters of the document to accommodate the first display size, and adjust, by the first computing device, based on the reflowing of the characters, a size or shape of the gesture-created marking in the document so that the gesture-created marking continues to encompass all tagged characters when displayed by the first computing device on the first display.

According to another general aspect, a method may include receiving a document at a first computing device having a display size that is different than a display size of a second computing device where a gesture-created marking was added to the document. The document includes the gesture-created image and a group of tagged characters. The method further includes adjusting a size or shape of the gesture-created marking in the document so that the gesture-created marking encompasses all tagged characters on the display of the first computing device. The adjusting is performed based on the display size of the first computing device being different than display size of the second computing device.

According to another general aspect, a computer program product may be provided that is tangibly embodied on a computer-readable storage medium having executable-instructions stored thereon. The instructions are executable to cause a processor to receive a document at a first computing device having a display size that is different than a display size of a second computing device where a gesture-created marking was added to the document. The document includes the gesture-created image and a group of tagged characters. The instructions may further cause the processor to adjust a size or shape of the gesture-created marking in the document so that the gesture-created marking encompasses all tagged characters on the display of the first computing device. The adjusting is performed based on the display size of the first computing device being different than display size of the second computing device.

According to another general aspect, a method may include storing a gesture-created marking in a document that encompasses a group of characters in the document. The method may further include tagging each of the characters encompassed by the gesture-created marking and receiving edits within the group of characters that were tagged, the edits including character deletions from the group or new characters added within the group. The method may also include tagging any new characters added to the group, and adjusting a size or shape of the gesture-created marking to encompass the edited group of characters such that the adjusted gesture-created marking still encompasses all tagged characters.

According to another general aspect, an apparatus may include at least one processor; and at least one memory including computer program code. The at least one memory and the computer program code are configured to, with the at least one processor cause the apparatus to at least store a gesture-created marking in a document that encompasses a group of characters in the document and tag each of the characters encompassed by the gesture-created marking. The apparatus is further caused to receive edits within the group of characters that were tagged. The edits include character deletions from the group or new characters added within the group. The apparatus is further caused to tag any new characters added to the group, adjust a size or shape of the gesture-created marking to encompass the edited group of characters such that the adjusted gesture-created marking still encompasses all tagged characters.

According to another general aspect, a method may include storing, based on a first gesture by a user, a marking in a document that encompasses a group of characters in the document, and adjusting a size or shape of the marking based on a second gesture from a user.

According to another general aspect, an apparatus may include at least one processor, and at least one memory including computer program code. The at least one memory and the computer program code are configured to, with the at least one processor cause the apparatus to at least store, based on a first gesture by a user, a marking in a document that encompasses a group of characters in the document. The apparatus is further caused to adjust a size or shape of the marking based on a second gesture from a user.

According to another example embodiment, a method may include storing a gesture-created marking in a document that encompasses a group of characters in the document, and adjusting a size of the gesture-created marking to encompass at least one or more grammatical units of characters based on semantic analysis of at least a portion of the document.

According to another general aspect, an apparatus may include at least one processor, and at least one memory including computer program code. The at least one memory and the computer program code are configured to, with the at least one processor cause the apparatus to at least store a gesture-created marking in a document that encompasses a group of characters in the document. The apparatus is further caused to adjust a size of the gesture-created marking to encompass at least one or more grammatical units of characters based on semantic analysis of at least a portion of the document.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system according to an example embodiment.

FIG. 2 is a diagram illustrating an example embodiment of how a gesture-created marking on a document may be adjusted for a different display size.

FIG. 3 is a diagram illustrating an adjustment of a marking according to an example embodiment.

FIG. 4 is a diagram illustrating automatic adjustment of a marking according to another example embodiment.

FIG. 5 is a block diagram showing example or representative structure, devices and associated elements that may be used to implement the computing devices and systems described herein.

FIG. 6 is a diagram illustrating automatic adjustment of a marking according to another example embodiment.

FIG. 7 is a diagram illustrating the creation of a marking on a document based on an expanding touchpoint according to an example embodiment.

FIG. 8 is a flow chart illustrating operation according to an example embodiment.

FIG. 9 is a flow chart illustrating operation according to an example embodiment.

FIG. 10 is a flow chart illustrating operation according to an example embodiment.

FIG. 11 is a flow chart illustrating operation according to an example embodiment.

FIG. 12 is a flow chart illustrating operation according to yet another example embodiment.

### DETAILED DESCRIPTION

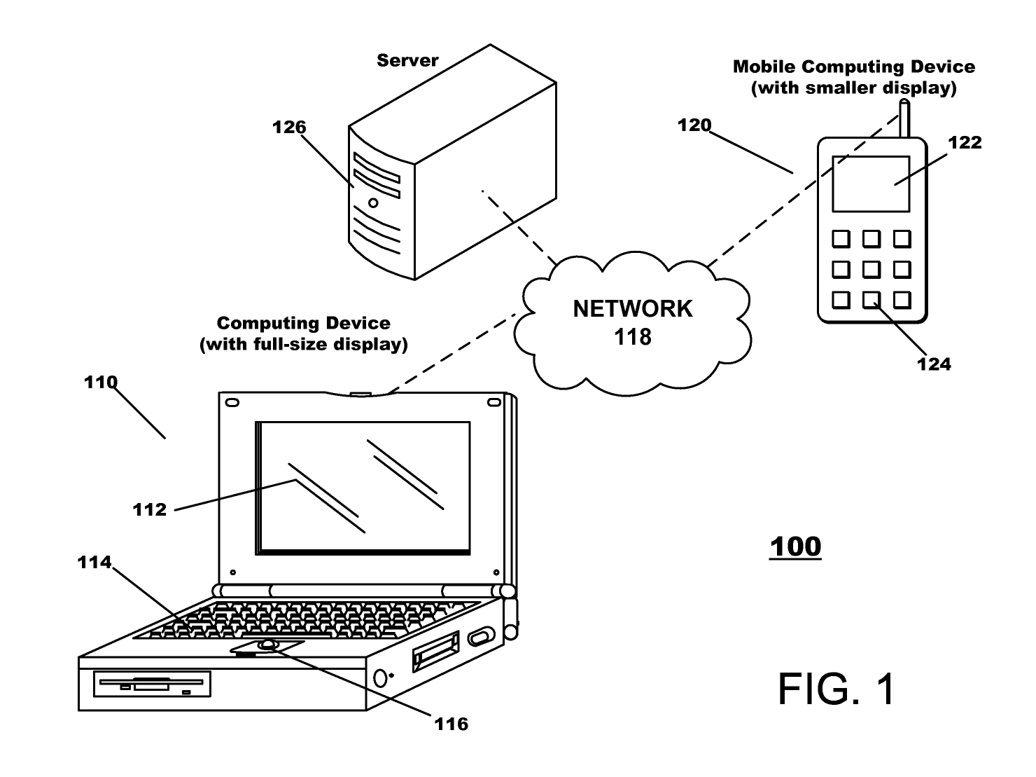

FIG. 1 is a block diagram of a system according to an example embodiment. System 100 may include a variety of computing devices connected via a network 118. Network 118 may be the Internet, a Local Area Network (LAN), a wireless network (such as a wireless LAN or WLAN), or other network, or a combination of networks. System 100 may include a server 126, and one or more computing devices, such as a computing device 110, and a mobile computing device 120. System 100 may include other devices, as these are merely some examples.

Server 126 may receive and store documents or information, and may allow other computing devices to store and retrieve documents or information thereon. Server 126 may include a processor for executing software, a memory, and a network interface, for example.

Computing device 110 may be a laptop 110 having a full-size display 112, a keyboard 114, a pointing device 116 (such as a track ball, mouse, touch pad or other pointing device). Display 112 may be considered full-size since it is sufficient height and width, e.g., to allow documents to be displayed without excessive horizontal scrolling or without reformatting documents. A full-size display may include a number of different display sizes and types, such as displays that are commonly found on laptops, and used with desktop computers, as examples.

In an example embodiment, display 112 may be a touch-sensitive display or touchscreen that can detect the presence and location of a touch within the display area. The touchscreen may be touched with a hand, finger or stylus or other object. A touchscreen may allow a user to interact directly with what is displayed by touching the screen, rather than interact indirectly by controlling a cursor using a mouse or touchpad.

Mobile computing device 120 may be a cell phone, PDA, a wireless handheld device, or any other handheld portable computing device. Computing device 120 may include a display 122, a keypad 124. Display 122 may be any type of display, and in one example embodiment, may be a touch-sensitive display or touchscreen in which a user may directly interact with what is displayed by touching the screen or display with a finger, hand, stylus, etc. Although not shown in FIG. 1, mobile computing device 120 may include a processor for executing software or instructions, a memory for storing instructions and other information, input/output devices, and an accelerometer to detect motion of the computing device.

According to an example embodiment, a user at computing device 110 or at mobile computing device 120 may create or edit a document using computing device that may include characters, such as text, punctuation, etc. The document may include other information such as graphics or images, tables, formulas, and other information. The user may, for example, create or add a marking to the document using a gesture, which may be referred to as a gesture-created marking. For example, a user may add a marking to a document as a way to identify a portion of the document to another user. A user may select a “marking” mode (or “annotation” mode) from a menu, and may then create or add a circle, polygon or irregular shaped marking (or provide other marking to encompass) around a portion of text or images in the document. In addition, the user may click on or select the marking, and then select “add comment” to add a comment associated with the marking. For example, a user may draw a circle, or irregular shape substantially around two sentences, and then add a comment: “Frank, please expand the idea in these sentences to provide more detail.”

The gesture-created marking may be created a variety of different ways. For example, a user may use his finger to circle an area of text (or group of characters) in the document (e.g., touching the screen or display) where the circle/marking encompasses or substantially encompasses a group of characters. The user may use a finger or hand or stylus (or a touchpad or other pointing device) to draw a polygon (e.g., box, rectangle) or an irregular shape around a group of characters, e.g., by dragging a finger or stylus across the screen to draw the desired shape, or by using a pointing device or touchpad. Thus, a gesture-created image is not limited to a particular size or shape marking.

As another example, a gesture created image may also be created by a user creating a circle based on an time-expanding touchpoint where the user may touch a finger to the screen (or use a pointing device or touchpad to touch or click on a point in the document) on a point in the document and having a circle start from that point and grow outwardly until the finger (or pointing device or touchpad) is released from that point to create a circle or other shape that encompasses a group of characters. A user may touch the display one or more successive times to create a circle, polygon or other shaped marking that varies (e.g., increases) in size around the touched point, e.g., increasing in size each time the user presses on the display.

For the marking to encompass a group of characters in a document, the gesture-created image may only substantially encompass the group of characters. In other words, the circle, rectangle, or other shape may be imperfect, and may have lines that do not touch (e.g., a marking that encompasses a group of characters may not be completely closed). Different techniques may be used to determine if a marking encompasses a group of characters or other objects (e.g., images). If the gap between two non-touching lines of the marking is less than a threshold, then the computing system may consider such lines as connected (or as virtually connected) and will include all characters within the physical boundary of such marking as being encompassed by the marking, even though the marking is not closed, for example. Thus, the computing system may virtually connect edges of two untouching lines on the marking if the space or gap between the edges (or lines) is less than, for example, 2% of the total perimeter of the marking This is merely an example, and other thresholds, and other techniques may be used to allow imperfect shaped markings and markings that may not be closed or touching to nonetheless be considered as encompassing a group of characters.

Other gestures (other than dragging a finger or stylus on touch screen to draw the marking, or using a touchpad or pointing device to draw the marking, or touching a point on the document, etc.) may be used to create or add a marking to a document, such as by touching a point in the document (either by finger or stylus on a touchscreen, or a pointing device or touchpad on the document) and then shake the mobile computing device once to select the entire sentence that includes the touched character(s), and e.g., shake the mobile computing device twice to select the entire paragraph that includes the touched (or identified) character(s). In addition to shaking, other gestures may be used to automatically select a sentence, paragraph, etc., such as rotating, twisting, performing a slash motion, tilting, etc. the computing device in different directions. A marking, e.g., circle, square, or irregular shape may be automatically generated and placed around the selected text in the document after such gesture. Some of these gestures may be more easily accomplished using a mobile computing device, such as device 120, since such device is smaller and may be more easily moved, twisted, shaken, tilted, etc.

A mobile computing device 120 may include an accelerometer (or other device) to detect motion or acceleration of the computing device in different directions. The accelerometer may detect motion of the device that may be twisting, tilting, rotating, shaking, etc., and the accelerometer may send a signal to the processor of the device notifying it of the detected motion. Laptops and other computing devices may also include an accelerometer.

Therefore, according to one example embodiment, a user may add a gesture-created marking to a document. In an example embodiment, the gesture-created marking (or gesture-created image) may be created or added to the document by a user making one or more gestures, which may include circling, pressing, drawing, etc., or other gesture to create a marking (or shape) on a document, for example. For example, a stylus or finger may be used to create the marking by pressing or drawing on a touchscreen, or a mouse, touchpad or other pointing device (e.g., via a regular display) may be used by a user to make a gesture to create the marking

The marking may encompass a group of characters (and other objects such as images) in the document. Different techniques may be used to determine which characters (or which objects) are considered within (or encompassed by) the marking, and which are not. For example, characters may be considered within or encompassed by a marking if: 1) each character of a group of characters fall completely within the physical boundary of the marking, or 2) each character of a group of characters at least partially falls within the boundary of the marking, or 3) each character of a group of characters either touches the marking or at least partially falls within the physical boundary of the marking These are examples of how it may be determined which characters are encompassed by the marking and which characters are not. In an example embodiment, each such character in the document that is encompassed by the marking may be tagged, or in other words, may be associated with the marking

As noted, a user of either computing device 110 or 120 may create a document, or may add a marking (e.g., gesture-created marking or image) to the document where the marking may encompass a group of characters or images in the document. This marking may be used, for example, to identify a section of the document to another user, where a comment or other information may be added and associated with the marking The document (including the added marking) may be stored in server 126.

Difficulties may arise when a marking was added to the document by a first user using a computer having a screen of one size, and the document (and marking) is later (or simultaneously) viewed using a computing device having a different display size. Display sizes of different sizes have different line widths (or line lengths). Thus, a sentence or group of words that fit on one line on a full-size display may be reflowed and displayed on multiple lines for a smaller display (e.g., for a mobile computing device). Likewise, text or characters that fit on multiple lines of a mobile device (or a device having a display that is less than full size) may be reflowed and displayed on one line of the full-size display, for example. Thus, reflowing of text (and images or other objects) may include changing or modifying the location (or relative location) of characters (or objects) on a display or screen based on a change in display size. However, in some cases, after text (or other objects) has been reflowed from one display size to another, the marking on the new display size may not accurately identify or reflect the original marking (or the meaning of the original marking)

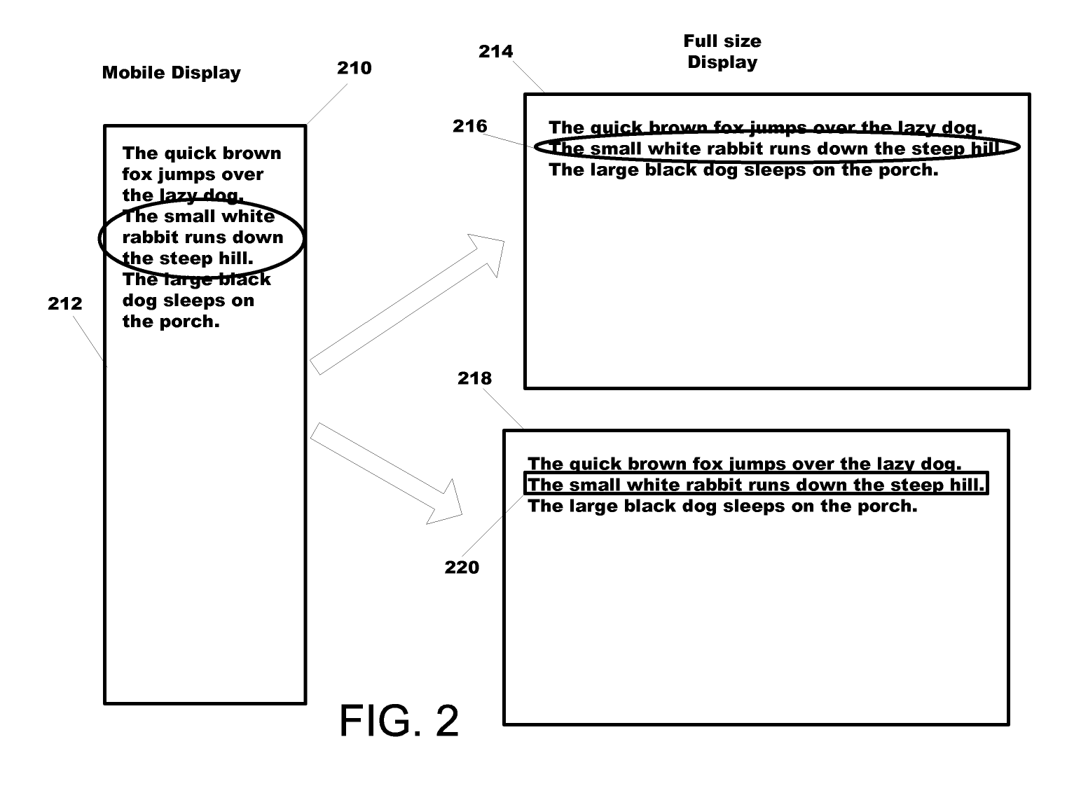

FIG. 2 is a diagram illustrating an example embodiment of how a gesture-created marking on a document may be adjusted for a different display size. A display 210 of a mobile computing device includes a document with some text or characters. A user of the mobile computing device may add or create a marking 212, shown in FIG. 2. For example, the user may use his finger or stylus or other pointing device to circle or draw a mark around a group of characters, or may use a mouse or touchpad to circle (or draw a mark around) the group of characters, as shown. The words on display 210 that fall completely (for example) within the boundary of the mark 212 include “The small white rabbit runs down the steep hill.”

An example of a full-size display 214 is also shown, where each line of full-size display 214 is longer than each line of the mobile display 210, for example. Therefore, when displaying the same document, the text may be reflowed on full size display 214, e.g., relative location of characters or words may be adjusted based on the different screen size, and also possibly based on a different font size that may be used. For example, only three words (The quick brown) of the document are shown on the first line of display 210. Whereas nine words (The quick brown fox jumps over the lazy dog) are shown on the first line of the full size display 214. Thus, in this example, six words (fox jumps over the lazy dog) displayed on the second and third lines of mobile display 210 are reflowed onto the first line based on the differences in display or screen size (and possibly other factors such as differences in margins and font sizes used on the two different screen sizes). A reflowing (or rearranging) of text may occur for text when displaying text from a large or full-size display to a smaller or mobile display or screen size.

In an example embodiment, the full size computing device (e.g., laptop, desktop) may also adjust the size or shape of the gesture-created marking 212, e.g., so that the marking still encompasses at least the same words as in mobile display 212, taking into account the change in display size and reflowing of text. For example, due to more words being provided on each line for the full size display 214 (as compared to the mobile display 210), the marking 216 on the full size display 214 is longer than the marking 212. Marking 216 encompasses at least the same words (The small white rabbit runs down the steep hill) as that encompassed (or bounded) by marking 212, and also may encompass (or include within its boundary) some additional words (in one example embodiment), due to the shape of the marking 216.

Referring to FIG. 2, display 218 shows another example of how marking 212 (on display 210) has been adjusted to become marking 220 after reflowing of text onto the full size display 218. Marking 220 is a different shape than the original marking 212 (rectangular in shape or using straight lines and 90 degree corners for marking 220, as opposed to oval or round shape for marking 212). Marking 220 is also a different shape of marking, and a different size, and may provide a tighter fit around the words (as compared to marking 216) that were originally within the bounds (or encompassed by) the marking 212.

Therefore, in an example embodiment, a computing device (e.g., mobile computing device 120) may be configured (or programmed) to adjust a size and shape of a marking based on a different display size (and possibly other factors, such as different margins and tab sizes, and different font sizes). For example, a computing device (e.g., computing device 120) may increase a height of the marking relative to the width of the marking, to accommodate a reflowing of text onto a display 122 that has a line width or length that is shorter than the line width or length of the original display 112. Similarly, a computing device (e.g., computing device 110) may be configured (or programmed) to configured to increase a width of the marking relative to the height of the marking, to accommodate a reflowing of text onto the (e.g., full-size) display 112 that have a line width or length that is longer than the line width or length of the original display 122.

In addition, a shape and size of a marking may be adjusted based on edits to the group of characters that have been tagged or are associated with the marking For example, the marking may be reduced in size if some the tagged characters are deleted. Also, the size of the marking may be increased if new characters or new words are added to (or within) the group of characters, e.g., words or characters added between a first character and a last character of the group (or if new characters are added between first tagged character and a last tagged character). Thus, in an example embodiment, the size or shape of the marking may not necessarily (or may not typically) change if there are edits outside the marking The edits and the revised marking size or shape may be displayed by the computing device where the edits are being performed, and may also be displayed (e.g., simultaneously, or, alternatively, later in time) on a display (of a different size) of another computing device.

Thus, for example, a marking may be added to a document by computing device 110 and displayed on display 112. This same marking may be displayed (either simultaneously as part of a collaboration between two users, or later in time) on display 122 of device 122, although the marking displayed on display 122 may be adjusted to have a different size or shape based on the display size differences. A user at device 120 may then edit the document, e.g., by adding or removing text from the group of tagged characters associated with the marking, and the marking may grow or shrink in size based on these edits, and the edited document (including the adjusted marking) may be displayed on both displays 122 and 112. Note that the adjusted marking 112 may be further adjusted by device 110 to account for the difference in display sizes of displays 112 and 122.

According to another example embodiment, a marking (such as a gesture-created marking) may be added to a document that is stored. The marking may encompass (or bound) a group of characters (e.g., a group of words or a portion of text). Each of the characters (or each of the words) may be tagged, or may be associated with the marking By this tagging or association, this may indicate that each of these characters or words is encompassed by the marking Various techniques for tagging or associating the group of characters with the marking. For example, a pointer to the first word or character may be stored in memory, along with the total number of characters or words that are encompassed. Alternatively, a pointer to the first and last characters may be stored in memory. If edits are performed to delete one of these characters or words, or change their location, then the pointer and other information stored for this marking may be updated to reflect the new group of characters that are tagged or associated with this marking. This is merely one example, and other techniques may be used to tag or record an association of each word or character with the marking that encompasses such words or characters, for example.

Once a group of characters (or a portion of text has been tagged or associated with a marking in a document), a user may edit that group of characters or portion of text, e.g., by deleting characters or words, or by adding new characters or words to the group. If a word or character is deleted from the group, the size or shape of the marking may be adjusted (e.g., decreased) to continue to encompass or bound all tagged characters. If new characters or words are added to the group, e.g., new word added between a first tagged character and a last tagged character, then this newly inserted word or character is also tagged or associated with the marking. The size or shape of the marking may be adjusted, e.g., increased, based on these new words or characters being added to the group. Both the creation of the marking and the edits to the group of characters may occur on one computing device, on two different computing devices having a same screen size, or may occur on computing devices that have different display sizes. In the latter case, where the marking is created on a first computing device with a first screen size and the group of characters and marking is edited and adjusted, respectively on a second computing device, further adjustment of the marking may occur at the first display device due to display size differences.

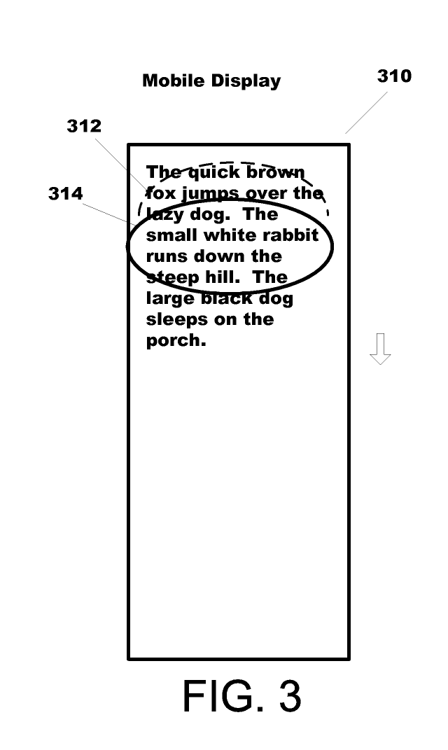

FIG. 3 is a diagram illustrating an example of how a user may create and then manually adjust a size of a marking A user may create a marking (e.g., gesture-created marking) on a document which is displayed on display 310. A user may create a marking that has an initial line at 312. The user decides that the circle 312 encompasses too much (or more than the user intended). The user then pushes on the line 312 until it moves to the position of the line 312 to the position shown by line 314. For example, the user may push a finger on a touch-screen at a location corresponding to the location of line 312, and slide the finger (and line 312) down the screen until the line 312 moves to a new location shown by line 314. In this manner, for example, a user may create or add a gesture-created marking to a document (e.g., using a first gesture, such as by drawing an oval), and then may manually adjust a size or shape or location of the marking using a second gesture, e.g., by pushing a portion of the marking to move it to the desired (or new) location.

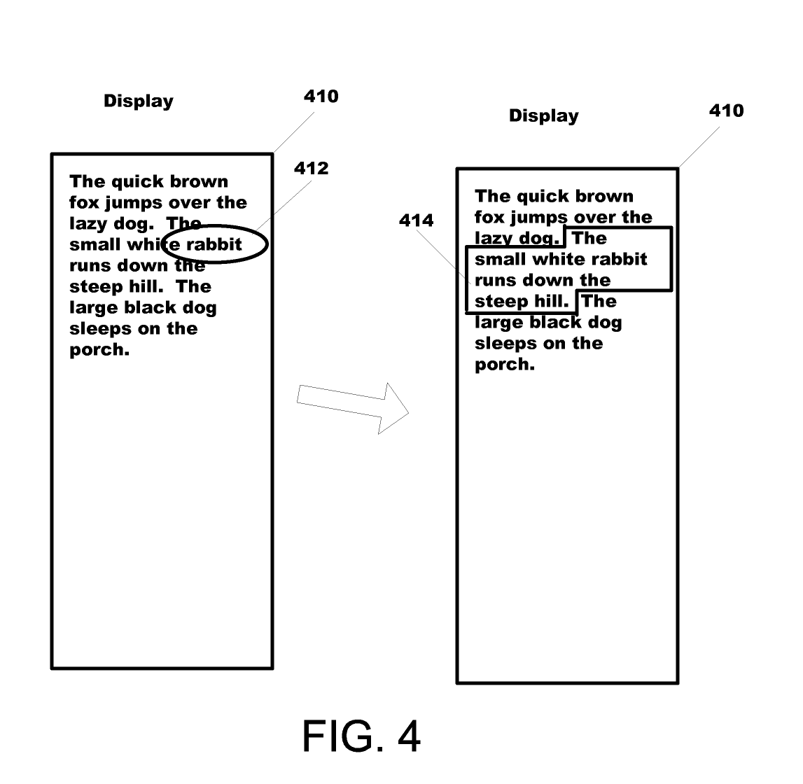

FIG. 4 is a diagram illustrating automatic adjustment of a marking according to another example embodiment. A user may create a marking 412 (e.g., gesture-created marking) on a document, which may be displayed on display 410. For example, a user may use his finger on a touchscreen (e.g., drag his finger across a touchscreen display), or may use another pointing device (e.g., mouse, trackball . . . ) to draw the marking 412, which may be an oval, rectangular, irregular, or any other shape. Marking 412 may encompass one or more characters or words, such as “rabbit”, as shown in FIG. 4. In this example embodiment, the computing device may automatically adjust a size of marking 412 to encompass at least one or more grammatical units of text/words, based on semantic analysis of at least a portion of the document. In this example, semantic analysis may include evaluating words, sentence structure, punctuation, etc., to determine a beginning and ending point for one or more grammatical units. Grammatical units of text may include a sentence, multiple sentences, a paragraph, and multiple paragraphs, for example.

Therefore, according to one example embodiment, a computing device may adjust a marking to encompass at least the sentence (or other grammatical unit) that includes the word(s) that are encompassed within the original marking 412. Thus, for example, a computing device may identify a word (or words) that are encompassed (e.g., partially or fully within the marking) and identify the beginning and ending of the sentence (or sentences or other grammatical unit) that includes the words encompassed by the original marking, e.g., based on detecting end of sentence punctuation, e.g., periods, question marks, exclamation points. Then, the size and shape of the marking may be adjusted to encompass at least the sentence(s). Thus, in this example, the grammatical unit is one sentence, but the grammatical unit may be one or more sentences, or one or more paragraphs, for example. Thus, as shown in FIG. 4, marking 412 may be adjusted (in this case increased in size) in size to include at least the sentence that included the originally encompassed word(s). The adjusted marking 414 may be increased, in this example, to include at least the sentence, “The small white rabbit runs down the steep hill,” since the original marking 412 included the word “rabbit.” In some cases, other words may be included in the adjusted marking The adjusted marking 414 may include an oval shaped marking (or other shape), or a more rectangular-shaped marking may be used to provide a tighter match to the grammatical unit. In this example, the creation of the marking 412 (by a user of a computing device), and the automatic adjusting (by a computer or processor) of the size and shape of the marking may occur on the same computing device (or with devices having a same size display).

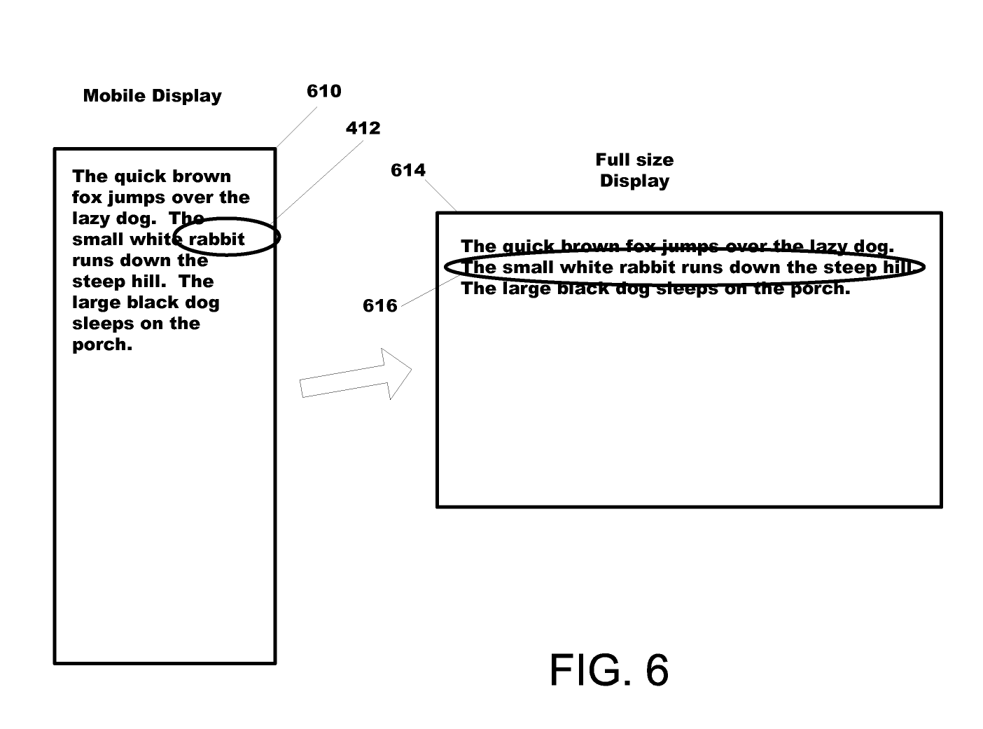

FIG. 6 is a diagram illustrating automatic adjustment of a marking according to another example embodiment. Alternatively, the creation or adding of the original marking 412 may occur using (or by) a computing device having a display of a first size (e.g., mobile computing device with a small display), and the marking may be automatically adjusted on a second computing device (e.g., full size device) to include or encompass at least one or more grammatical units of characters or text, where the second computing device has a display of a second (different) display size as compared to the first display size.

Referring to FIG. 6, a document is displayed on a mobile display 610 and a marking 412 is added (or created) using the mobile computing device associated with display 610. In this example, the word “rabbit” is within (or encompassed) by the marking 412. The full size (or second) computing device, having a display 614, may then adjust the size or shape of the marking, as displayed on display 614, to include or encompass at least one grammatical unit (e.g., sentence or paragraph) that includes the word “rabbit.” In this example, the grammatical unit is one sentence, but the grammatical unit may be another size. The adjusted marking 616 may be the same shape, e.g., oval, as the original marking, or may be a different shape, e.g., rectangular shape as shown in FIG. 4. Although the example in FIG. 6 shows a marking adjusted on a full-size (or larger) display 614 as compared to the original marking 412 on a mobile (or smaller sized) display 610, the adjustment may occur on a small-sized (or mobile) display based on an original marking provided on a larger or full-size display, for example.

A number of different grammatical units may be used, such as a paragraph. The computer may automatically adjust (e.g., increase or decrease) the size of the marking to include a grammatical unit, e.g., the next grammatical unit of text, e.g., sentence (of one word is encompassed, two sentences if words from two sentences are encompassed (or tagged) by the original marking, etc.

In an alternative embodiment, the computer may adjust (e.g., decrease) a size of a marking to include only a grammatical unit corresponding to words that were completely encompassed by original marking 412. If the grammatical unit, for example, is one sentence, and the original marking encompasses the word “rabbit,” then the new marking 616 may include the sentence shown as encompassed by marking 616. Note, that in another example embodiment, one computer (with one display or screen size) may both receive an original marking, and adjust the marking to include a grammatical unit, e.g., receive marking 412 around one word, and increase a size of the marking to encompass a grammatical unit that includes such word. Alternatively, a first computer and display/screen may receive the original marking 412, and a second computer with a different display size/screen size may adjust the size or shape of the marking to encompass a grammatical unit of text or characters.

In another example embodiment, the marking may be adjusted (e.g., increased in size) to include at least an entire sentence if the subject of the sentence is encompassed by the marking, or if both the subject and the verb of the sentence are encompassed or bounded within the original marking, for example. In another example embodiment, a marking may be adjusted to include an entire sentence if more than X % (e.g., more than 50%) of the words or characters in the sentence are encompassed or tagged by the original marking. In another example embodiment, a marking may be adjusted in size to include an entire paragraph if more than Y % (e.g., more than 50%) of the characters or words in the paragraph are encompassed (or tagged) by the original marking, or if at least one word from more than X % of the sentences of the paragraph are encompassed or tagged by the marking

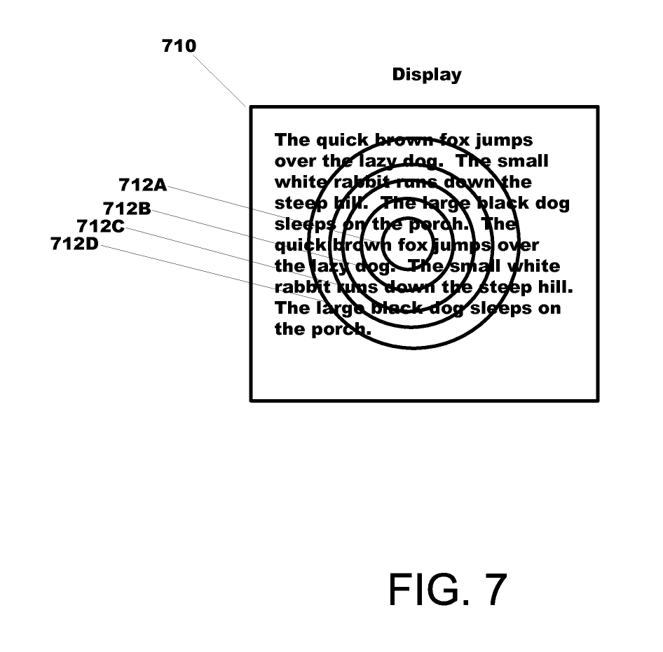

FIG. 7 is a diagram illustrating the creation of a marking on a document based on an expanding touchpoint, according to an example embodiment. As noted above, a gesture-created image may also be created by a user creating a circle (or other shape that encompasses text) based on an time-expanding touchpoint where the user may touch a finger to the screen or display 710 (or use a pointing device or touchpad to touch or click on a point in the document) on a point in the document. The computing system may then generate a marking as a selected one of a series of expanding circles 712A, 712B, 712C or 712D, centered at the touched point, for example. For example, initially, the small circle 712A is generated and displayed. If the user continues touching the point for ½ second (for example), then a second (larger) circle 712B is generated (and the first circle disappears). After 1 second (or another ½ second) of the user touching the point, a third circle 712 C is generated. The user may select a circle as the marking to be added to the document by simply releasing the touch on the display when the desired circle or marking appears, at such point the selected circle (or other shape) is stored in the document, and no further circles are generated for display. A user may alternatively touch the display one or more successive times to create a circle (other shaped marking) that varies (e.g., increases) in size around the touched point, e.g., increasing in size each time the user presses on the display, or increases in size each time the use performs some other gesture, e.g., shaking, tilting or rotating the mobile device.

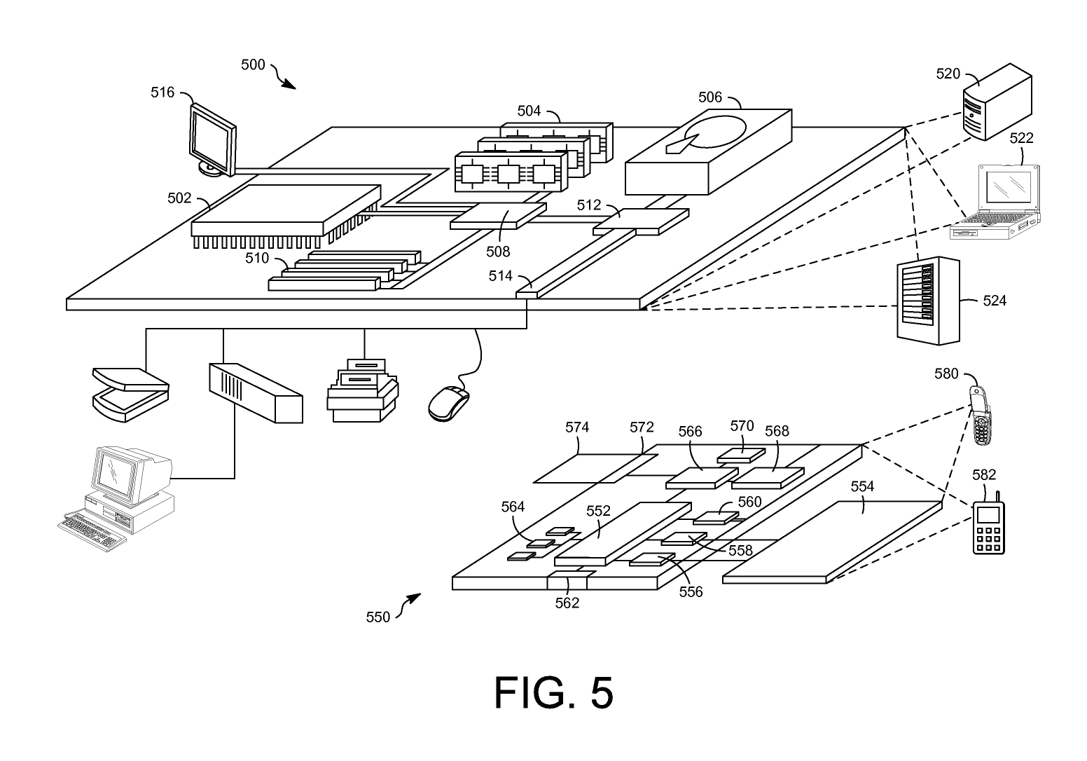

FIG. 5 is a block diagram showing example or representative structure, devices and associated elements that may be used to implement the computing devices and systems described herein, e.g., for desktop/laptop computing device 110 and mobile computing device 120. FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, and/or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display (or screen) 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, which may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning system) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

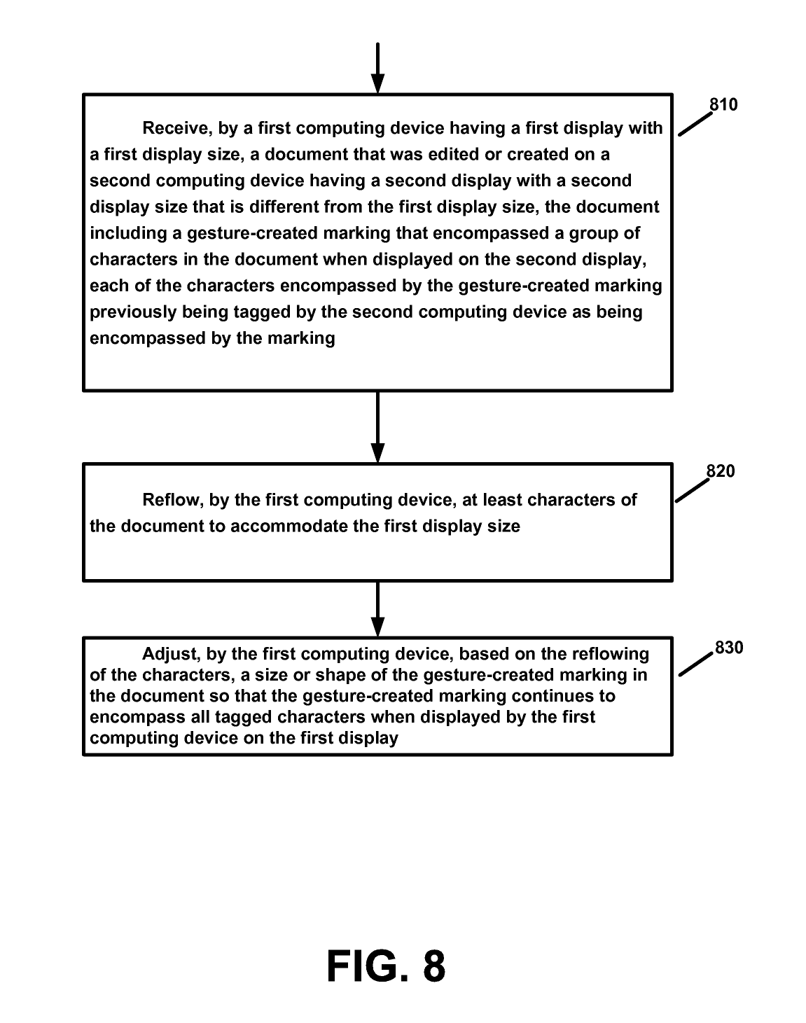

FIG. 8 is a flow chart illustrating operation according to an example embodiment. Operation 810 may include receiving, by a first computing device having a first display with a first display size, a document that was edited or created on a second computing device having a second display with a second display size that is different from the first display size. The document includes a gesture-created marking that encompassed a group of characters in the document when displayed on the second display. Each of the characters encompassed by the gesture-created marking were previously tagged by the second computing device as being encompassed by the marking Operation 820 may include reflowing, by the first computing device, at least characters of the document to accommodate the first display size. Operation 830 may include adjusting, by the first computing device, based on the reflowing of the characters, a size or shape of the gesture-created marking in the document so that the gesture-created marking continues to encompass all tagged characters when displayed by the first computing device on the first display.

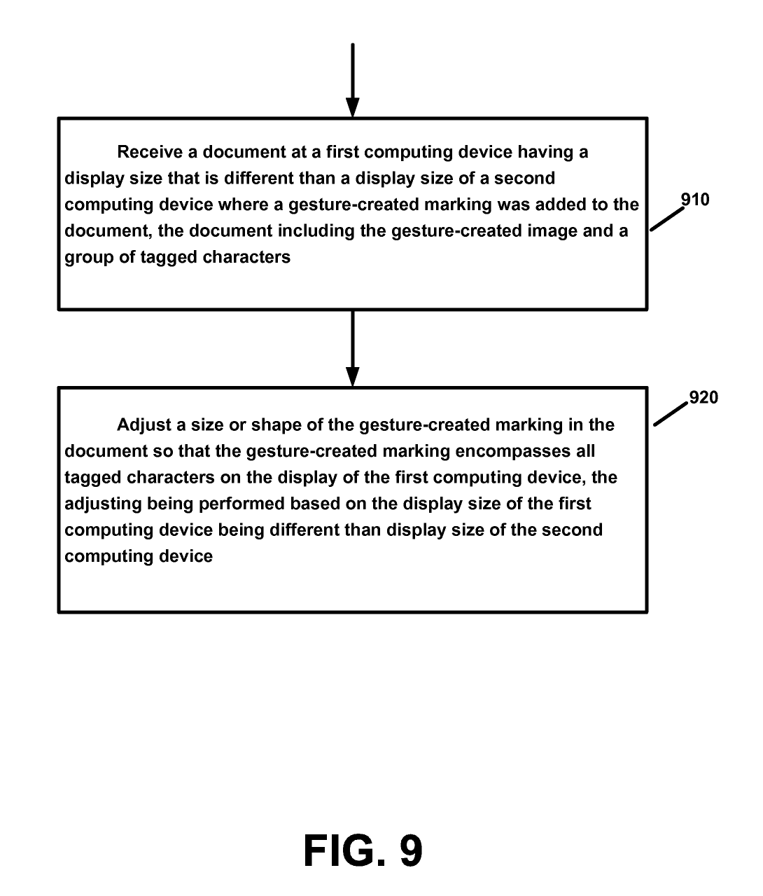

FIG. 9 is a flow chart illustrating operation according to another example embodiment. Operation 910 may include receiving a document at a first computing device having a display size that is different than a display size of a second computing device where a gesture-created marking was added to the document. The document includes the gesture-created image and a group of tagged characters. Operation 920 may include adjusting a size or shape of the gesture-created marking in the document so that the gesture-created marking encompasses all tagged characters on the display of the first computing device. The adjusting is performed based on the display size of the first computing device being different than display size of the second computing device.

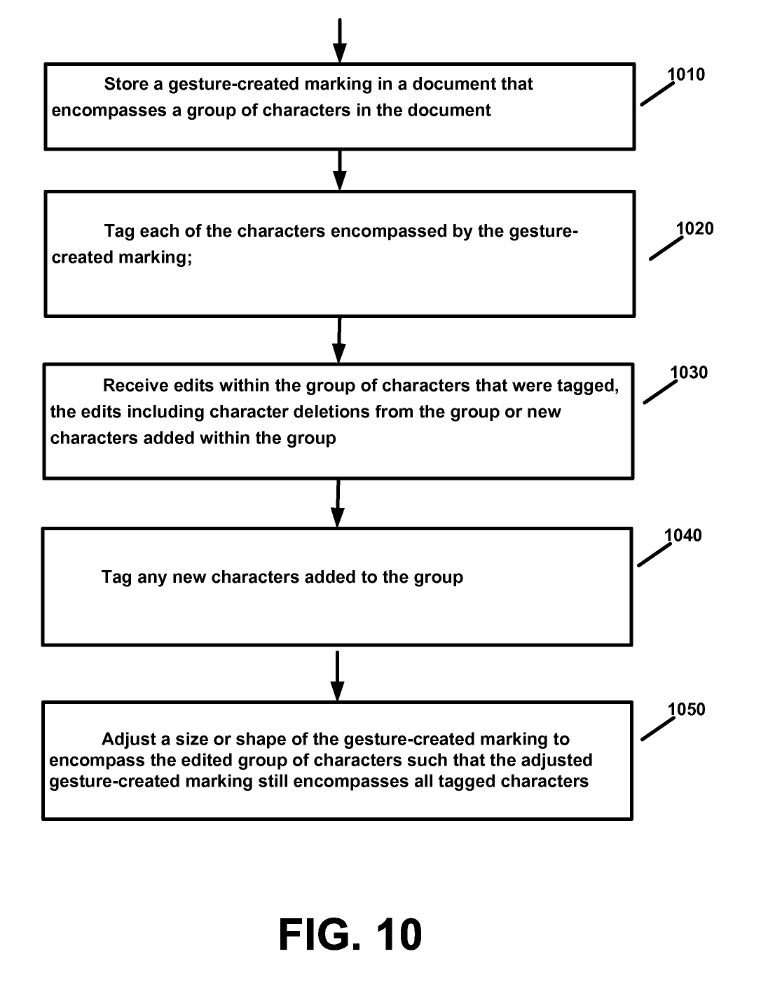

FIG. 10 is a flow chart illustrating operation according to another example embodiment. Operation 1010 may include storing a gesture-created marking in a document that encompasses a group of characters in the document. Operation 1020 may include tagging each of the characters encompassed by the gesture-created marking Operation 1030 may include receiving edits within the group of characters that were tagged. The edits include character deletions from the group or new characters added within the group. Operation 1040 may include tagging any new characters added to the group. Operation 1050 may include adjusting a size or shape of the gesture-created marking to encompass the edited group of characters such that the adjusted gesture-created marking still encompasses all tagged characters.

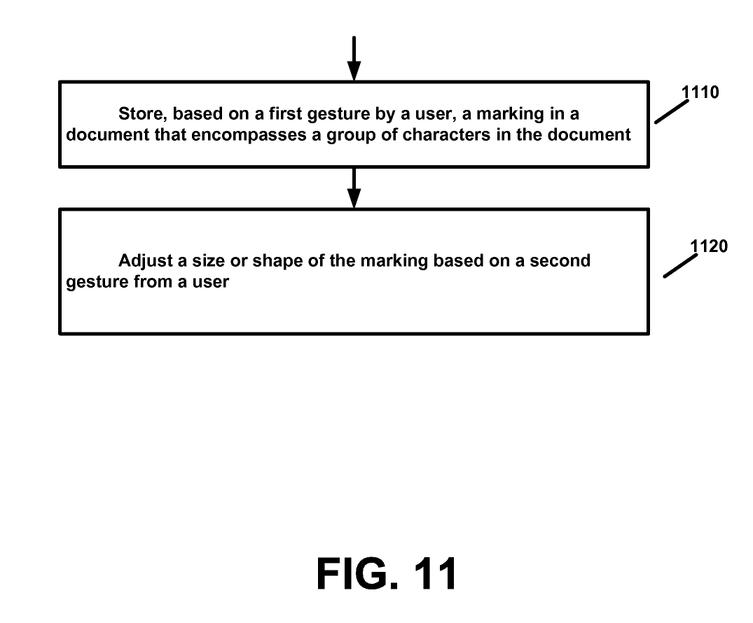

FIG. 11 is a flow chart illustrating operation according to another example embodiment. Operation 1110 may include storing, based on a first gesture by a user, a marking in a document that encompasses a group of characters in the document. Operation 1120 may include adjusting a size or shape of the marking based on a second gesture from a user.

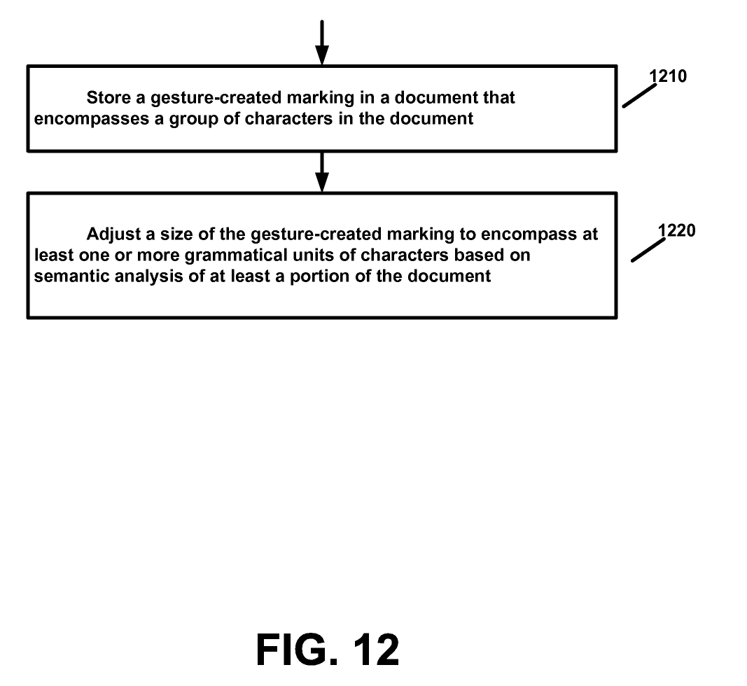

FIG. 12 is a flow chart illustrating operation according to yet another example embodiment. Operation 1210 may include storing a gesture-created marking in a document that encompasses a group of characters in the document. Operation 1220 may include adjusting a size of the gesture-created marking to encompass at least one or more grammatical units of characters based on semantic analysis of at least a portion of the document.

Thus, various implementations of the systems and techniques described here can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

What is claimed is:

1. An apparatus comprising:
at least one processor;
at least one memory including computer program code, the at least one memory and the computer program code configured to, with the at least one processor cause the apparatus to at least:
receive, by a first computing device having a first display with a first display size, a document that was edited or created on a second computing device having a second display with a second display size that is different from the first display size, the document including a gesture-created marking that encompassed a group of characters in the document when displayed on the second display, each of the characters encompassed by the gesture-created marking previously being tagged by the second computing device as being encompassed by the marking;
reflow, by the first computing device, at least characters of the document to accommodate the first display size; and
adjust, by the first computing device, based on the reflowing of the characters, a size or shape of the gesture-created marking in the document so that the gesture-created marking continues to encompass all tagged characters when displayed by the first computing device on the first display.

2. The apparatus of claim 1 wherein the first computing device comprises a mobile device and the second computing device comprises a computing device having a display with a display size that is larger than the display size of the mobile device.

3. The apparatus of claim 1 wherein the gesture-created marking comprises a hand-drawn marking drawn by a user of the second device using a finger or pointing device, the marking encompassing a group of characters of the document.

4. The apparatus of claim 1 wherein the gesture-created marking comprises an oval, circle, or polygon that encompasses the group of characters.

5. The apparatus of claim 1 wherein the apparatus being configured to adjust, by the first computing device, based on the reflowing of the characters, a size or shape of the gesture-created marking in the document comprises: the apparatus being configured to increase, by the first computing device, a height of the marking relative to the width of the marking, to accommodate a reflowing of text onto the first display that has a line width or length that is shorter than the line width or length of the second display.

6. The apparatus of claim 1 wherein the apparatus being configured to adjust, by the first computing device, based on the reflowing of the characters, a size or shape of the gesture-created marking in the document comprises: the apparatus being configured to increase, by the first computing device, a width of the marking relative to the height of the marking, to accommodate a reflowing of text onto the first display that have a line width or length that is longer than the line width or length of the second display.

7. The apparatus of claim 1 and the apparatus being further configured to:
adjust, by the first computing device, a size or shape of the gesture-created marking based on a deletion of characters from the group of characters or addition of characters between a first and last character of the group of characters

8. The apparatus of claim 1 and the apparatus being further configured to:
receive, by the first computing device, edits to at least the group of characters that were tagged, the edits including character deletions from the group or new characters added within the group; and
further adjust a size or shape of the gesture-created marking to encompass the edited group of characters.

9. The apparatus of claim 8 wherein the edits are performed at the second computing device, wherein at least the edited group of characters and the adjusted gesture-created marking being displayed substantially in real-time on at least the first display of the first computing device.

10. The apparatus of claim 8 wherein the edits are performed at the first computing device, wherein at least the edited group of characters and the adjusted gesture-created marking displayed on at least the first display of the first computing device.

11. A method comprising:
receiving, by a first computing device having a first display with a first display size, a document that was edited or created on a second computing device having a second display with a second display size that is different from the first display size, the document including a gesture-created marking that encompassed a group of characters in the document when displayed on the second display, each of the characters encompassed by the gesture-created marking previously being tagged by the second computing device as being encompassed by the marking;
reflowing, by the first computing device, at least characters of the document to accommodate the first display size; and
adjusting, by the first computing device, based on the reflowing of the characters, a size or shape of the gesture-created marking in the document so that the gesture-created marking continues to encompass all tagged characters when displayed by the first computing device on the first display.

12. A computer program product tangibly embodied on a computer-readable storage medium having executable-instructions stored thereon, the instructions being executable to cause a processor to:
receive, by a first computing device having a first display with a first display size, a document that was edited or created on a second computing device having a second display with a second display size that is different from the first display size, the document including a gesture-created marking that encompassed a group of characters in the document when displayed on the second display, each of the characters encompassed by the gesture-created marking previously being tagged by the second computing device as being encompassed by the marking;
reflow, by the first computing device, at least characters of the document to accommodate the first display size; and
adjust, by the first computing device, based on the reflowing of the characters, a size or shape of the gesture-created marking in the document so that the gesture-created marking continues to encompass all tagged characters when displayed by the first computing device on the first display.

13. A method comprising:
receiving a document at a first computing device having a display size that is different than a display size of a second computing device where a gesture-created marking was added to the document, the document including the gesture-created image and a group of tagged characters; and
adjusting a size or shape of the gesture-created marking in the document so that the gesture-created marking encompasses all tagged characters on the display of the first computing device, the adjusting being performed based on the display size of the first computing device being different than display size of the second computing device.

14. The method of claim 13 wherein the adjusting comprises:
reflowing at least characters of the document including the group of tagged characters based on the display size of the first computing device being different than display size of the second computing device; and
adjusting, based on the reflowing, a size or shape of the gesture-created marking in the document so that the gesture-created marking encompasses all tagged characters on the display of the first computing device.

15. A computer program product tangibly embodied on a computer-readable storage medium having executable-instructions stored thereon, the instructions being executable to cause a processor to:
receive a document at a first computing device having a display size that is different than a display size of a second computing device where a gesture-created marking was added to the document, the document including the gesture-created image and a group of tagged characters; and
adjust a size or shape of the gesture-created marking in the document so that the gesture-created marking encompasses all tagged characters on the display of the first computing device, the adjusting being performed based on the display size of the first computing device being different than display size of the second computing device.

16. A method comprising:
storing a gesture-created marking in a document that encompasses a group of characters in the document;
tagging each of the characters encompassed by the gesture-created marking;
receiving edits within the group of characters that were tagged, the edits including character deletions from the group or new characters added within the group;
tagging any new characters added to the group; and
adjusting a size or shape of the gesture-created marking to encompass the edited group of characters such that the adjusted gesture-created marking still encompasses all tagged characters.

17. The method of claim 16:
wherein the receiving edits comprises receiving new characters added between a first and last character of the group; and
wherein the tagging comprises tagging the new received characters; and
wherein the adjusting comprises adjusting a size or shape of the gesture-created image to encompass all tagged characters.

18. The method of claim 16:
wherein the receiving edits comprises receiving an indication of characters deleted between a first and last character of the group; and
wherein the adjusting comprising adjusting, based on the deleted characters, a size or shape of the gesture-created image to continue to encompass all tagged characters of the group.

19. The method of claim 16:
wherein the storing the gesture-created marking is performed by a first computing device having a first display size;
wherein the receiving the edits is performed by a second computing device having a second display size; and
the method further comprising further adjusting, by the second computing device, the size or shape of the gesture-created marking to account for the difference is display sizes between and first computing device and the second computing device.

20. An apparatus comprising:
at least one processor; and
at least one memory including computer program code, the at least one memory and the computer program code configured to, with the at least one processor cause the apparatus to at least:
store a gesture-created marking in a document that encompasses a group of characters in the document;
tag each of the characters encompassed by the gesture-created marking;
receive edits within the group of characters that were tagged, the edits including character deletions from the group or new characters added within the group;
tag any new characters added to the group; and
adjust a size or shape of the gesture-created marking to encompass the edited group of characters such that the adjusted gesture-created marking still encompasses all tagged characters.

21. A method comprising:
storing, based on a first gesture by a user, a marking in a document that encompasses a group of characters in the document; and
adjusting a size or shape of the marking based on a second gesture from a user.

22. The method of claim 18 wherein the storing comprises storing a marking drawn by a user that encompasses a group of characters based on movement of a user's finger on a touch-sensitive display device.

23. The method of claim 21, the adjusting including moving a portion of the gesture-created marking based on a motion of a user's finger or other user input with respect to the gesture-created image to include additional characters within the marking or to exclude characters that were previously included within the marking.

24. The method of claim 18 wherein the storing comprises storing a marking drawn by a user via touch-sensitive display device that encompasses the group of characters; and
wherein the adjusting comprises adjusting a size or shape of the marking based on user input via the touch-sensitive display device to move at least a portion of the marking

25. An apparatus comprising:
at least one processor; and
at least one memory including computer program code, the at least one memory and the computer program code configured to, with the at least one processor cause the apparatus to at least:
store, based on a first gesture by a user, a marking in a document that encompasses a group of characters in the document; and
adjust a size or shape of the marking based on a second gesture from a user.

26. A method comprising:
storing a gesture-created marking in a document that encompasses a group of characters in the document; and
adjusting a size of the gesture-created marking to encompass at least one or more grammatical units of characters based on semantic analysis of at least a portion of the document.

27. The method of claim 26 wherein the grammatical units of characters are selected from the group consisting of:
a sentence;
multiple sentences;
a paragraph; and
multiple paragraphs.

28. The method of claim 26 wherein the adjusting comprises:
identifying a subject of a sentence that includes the group of characters; and
increasing a size of the gesture-created marking to encompass the sentence if the group of characters includes the subject.

29. The method of claim 26 wherein the adjusting comprises:
identifying a subject and a verb of a sentence that includes the group of characters; and
increasing a size of the gesture-created marking to encompass the sentence if the group of characters includes both the subject and verb.

30. The method of claim 26 wherein the adjusting comprises:
identifying one or more sentences that include at least one character of the group of characters; and
increasing a size of the gesture-created marking to include the one or more sentences.

31. The method of claim 26 wherein the adjusting comprises adjusting a size of the gesture-created marking to encompass at least all characters of a sentence if more than a specific percentage of characters of the sentence are within the group.

32. The method of claim 26 wherein the adjusting comprises adjusting a size of the gesture-created marking to encompass at least all characters of a paragraph if more than a specific percentage of characters of the paragraph are within the group.

33. The method of claim 26 wherein the adjusting comprises adjusting a size of the gesture-created marking to encompass at least all characters of a paragraph if more than a specific percentage of sentences of the paragraph are within the group.

34. An apparatus comprising:
at least one processor; and
at least one memory including computer program code, the at least one memory and the computer program code configured to, with the at least one processor cause the apparatus to at least:
store a gesture-created marking in a document that encompasses a group of characters in the document; and
adjust a size of the gesture-created marking to encompass at least one or more grammatical units of characters based on semantic analysis of at least a portion of the document.
